(19) United States
(12) Patent Application Publication
(10) Pub. No.: US 2004/0221527 A1
(43) Pub. Date: Nov. 11, 2004

(54) Door frame protector

(76) Inventor: Sean R. Sykora, North Bergen, NJ (US)

Correspondence Address: Richard C. Litman, LITMAN LAW OFFICES, LTD., P.O. Box 15035, Arlington, VA, 22215, US

(21) Appl. No.: 10/774,597

(22) Filed: Feb. 10, 2004

Related U.S. Application Data
(60) Provisional application No. 60/445,794, filed on Feb. 10, 2003.

(51) Int. Cl. E06B 1/34

(52) U.S. Cl. 52/213

(57) ABSTRACT

The door frame protector comprises a set of elongated preformed, flexible and durable plastic pieces adapted to cover the lower halves of door frames. A latch side piece of the set has a partial elliptic, C-shaped cross-section having inwardly curled edges to protect the door latch side of a door frame. A hinge side piece, adapted to fit the door hinge side of a door frame, is similar to the first but has only a single inwardly curled edge, having a J-shaped cross section. The missing inwardly curled edge allows the second piece to be fitted to the hinge side of a door frame, clearing the door hinges. Securing pieces are short lengths having the same shape and cross section as the latch side piece, and are placed over the hinge side piece surrounding the door hinges, holding the hinge side piece in place.

### CROSS-REFERENCE TO RELATED APPLICATION

This application claims the benefit of U.S. Provisional Patent Application Ser. No. 60/445,794, filed Feb. 10, 2003.

### BACKGROUND OF THE INVENTION

1. Field of the Invention

The present invention relates generally to door protective devices. More specifically, the invention is door frame protector for protecting the lower half of the doorframes from hazards and during construction, reconstruction, remodeling, moving, or from traffic in and out of a residential or commercial space.

2. Description of Related Art

The relevant art of interest describes various door protectors, but none discloses the present invention. There is a need for a simplified, economical, and easy to attach and detach door jamb protector device. The relevant art will be discussed in the order of perceived relevance to the present invention.

U.S. Pat. No. 4,768,320 issued on Sep. 6, 1988, to Rick W. Weller describes a U-shaped doorjamb guard for protecting a door jamb and door trim having a relatively stiff outer shell of rubber or plastic and a relatively soft inner lining of soft rubber or vinyl which overlies and engages the door jamb and protruding door trim. The door guard is distinguishable for requiring a two-layered doorjamb cover having a stiff outer layer and a soft inner layer.

U.S. Pat. No. 1,620,933 issued on Mar. 15, 1927, to Joseph T. Wilcox describes a door jamb protector comprising a length of relatively soft fabric having spring clamping members at its ends and stretching members intermediate the clamping members. The casing protector is distinguishable for requiring a fabric cover with spring clamping and stretching members.

U.S. Pat. No. 5,799,443 issued on Sep. 1, 1998, to Charles D. Koeniguer describes a temporarily installed resilient, shock-absorbent two-piece cover set made from molded expanded polystyrene board, extruded vinyl, polypropylene, compressed paper fibers, and cardboard to protect the vulnerable parts of doors, door frames, and archways during moving of furniture. The hinge side cover which covers only between the door hinges is L-shaped, has an intermediate door catch and an elastic strap with a J-shaped door clip to attach to the outside edge of the door. The latch side frame cover comprises a cover backed by a center panel having retainer clips with tabs on the top and bottom ends. Archways can have two latch side frame covers. The latch side frame covers are distinguishable for requiring retaining clips on top and bottom ends.

U.S. Pat. No. 5,775,045 issued on Jul. 7, 1998, to Donald L. Hill describes a door frame guard made of magnetic vinyl material comprising a plurality of interface members connected by linking members to fit both sides of a door. The flexible vinyl layer is backed by strips of magnetic vinyl. The door frame guard is distinguishable for being limited to metal doors. U.S. Pat. No. 5,203,130 issued on Apr. 20, 1993, to James W. Freelove describes a door frame shield having four interlocking plastic strips to extend about and longitudinally of the inside surfaces and the front and rear edges of a jamb and door stop, and outwardly about the front and rear casings of a related door frame structure. The shield includes elongate front and rear inside sections of extruded plastic to engage about and extend longitudinally of the jamb and doorstop. The doorframe shield is distinguishable for requiring multiple interlocking parts.

U.S. Pat. No. 2,837,787 issued on Jun. 10, 1958, to Carl C. Wright describes a protective and decorative plastic device for doorjambs and archways comprising a length of a web with two side flanges bent flat. The device is distinguishable for having only three flat surfaces.

U.S. Design Pat. No. 408,089 issued on Apr. 13, 1999, to Phrixos Prodromou describes as best understood an ornamental design for a jamb cover attachment between a door and a door-frame. The cover has five parallel facets of different widths marked by indentations to cover a doorjamb. The ornamental cover is distinguishable for requiring five facets.

None of the above inventions and patents, taken either singly or in combination, is seen to describe the instant invention as claimed.

### SUMMARY OF THE INVENTION

The invention is a door frame protector comprising a set of elongated preformed, flexible and durable plastic pieces adapted to cover the lower halves of doorway jambs. Latch side piece of the set has a partial elliptic, C-shaped cross-section having inwardly curled edges to protect the door latch side of a door frame.

A hinge side piece, adapted to fit the door hinge side of a door frame, is similar to the first but has only a single inwardly curled edge, having a J-shaped cross section. The missing inwardly curled edge allows the second piece to be fitted to the hinge side of a door frame, clearing the door hinges.

Securing pieces are short lengths having the same shape and cross section as the latch side piece, and are placed over the hinge side piece surrounding the door hinges, holding the hinge side piece in place. One of these securing pieces is placed between the middle and lower hinges (of a door hung with three hinges). A second securing piece is placed below the lower hinge, while a third securing piece is placed above the upper hinge. The length of the securing pieces may be selected to accommodate a particular door hinge placement. For a standard door hung with three hinges, a seventeen and a half inch securing piece is sufficient to fit between the middle and lower hinges, while a nine inch securing piece will fit above and below the hinges.

These three freely movable securing pieces allow for any and all hinge placement, and give the door frame protector versatility in use. The door frame protector may be used with or without a door in place, because the pieces are readily installed surrounding door hinges and are easily placed between the door and door frame. These devices can be used on a doorframe with a throat size as small as 3-3.75 inches to as much as 6 inches, because of the characteristics of the plastic composition of the devices.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a door frame protector according to the present invention.

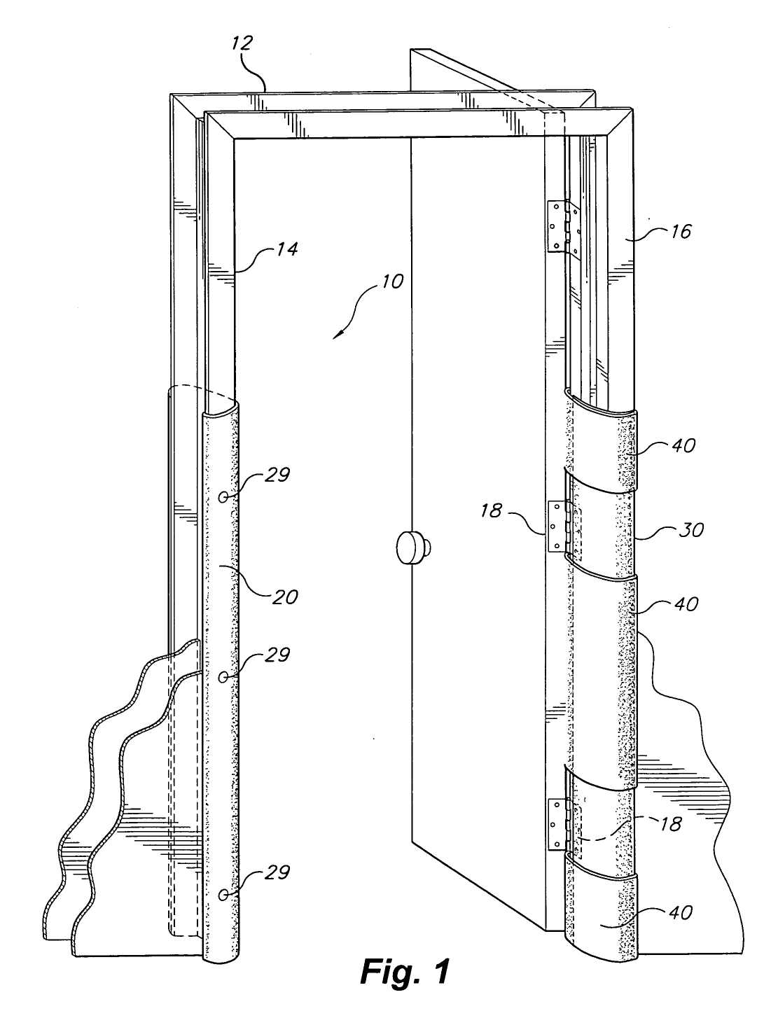

FIG. 2 is a perspective view of the parts of a door frame protector according to the present invention.

FIG. 3 is a perspective view of an alternate embodiment of a hinge side door frame protector according to the present invention.

FIG. 4 is a cross sectional view of a door frame protector according to the present invention.

Similar reference characters denote corresponding features consistently throughout the attached drawings.

### DETAILED DESCRIPTION OF THE PREFERRED EMBODIMENT

The present invention is a door frame protector, designated generally as 10 in the drawings. The door frame protector includes a latch side protector 20 and a hinge side protector 30. The latch side protector 20 snaps in place over the latch side 14 of a door frame 12, while the hinge side protector 30 is held in place on the hinge side 16 of a door frame 12 by at least one securing piece 40. Securing pieces 40 are placed on either side of hinges 18

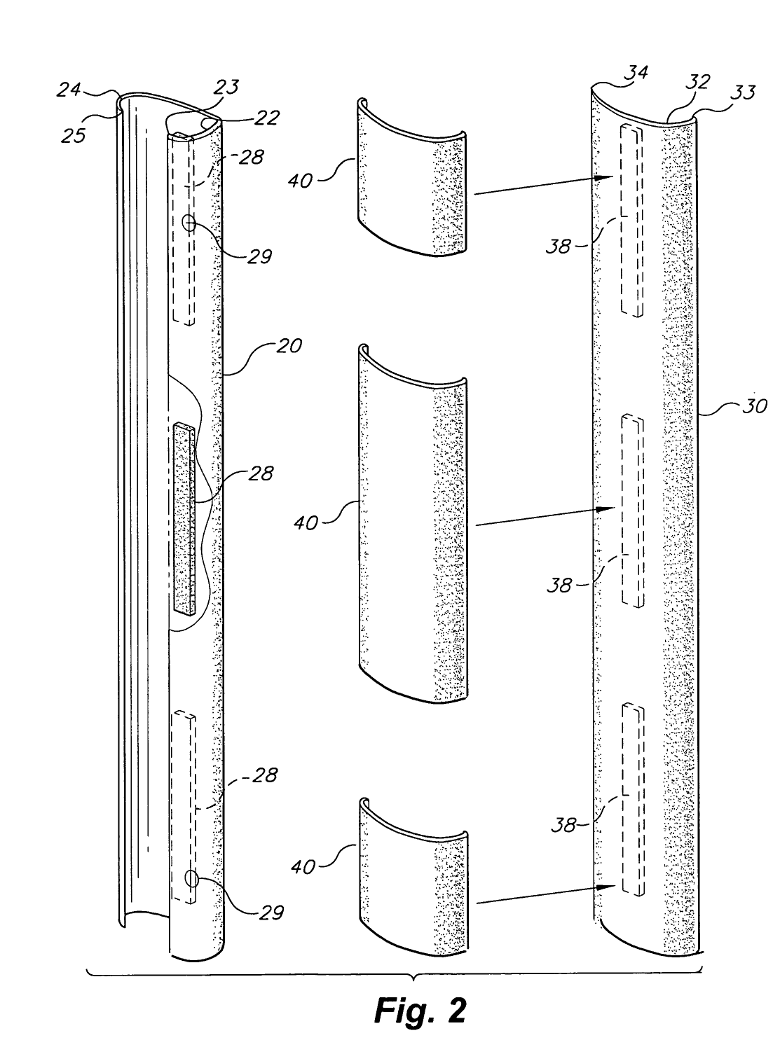

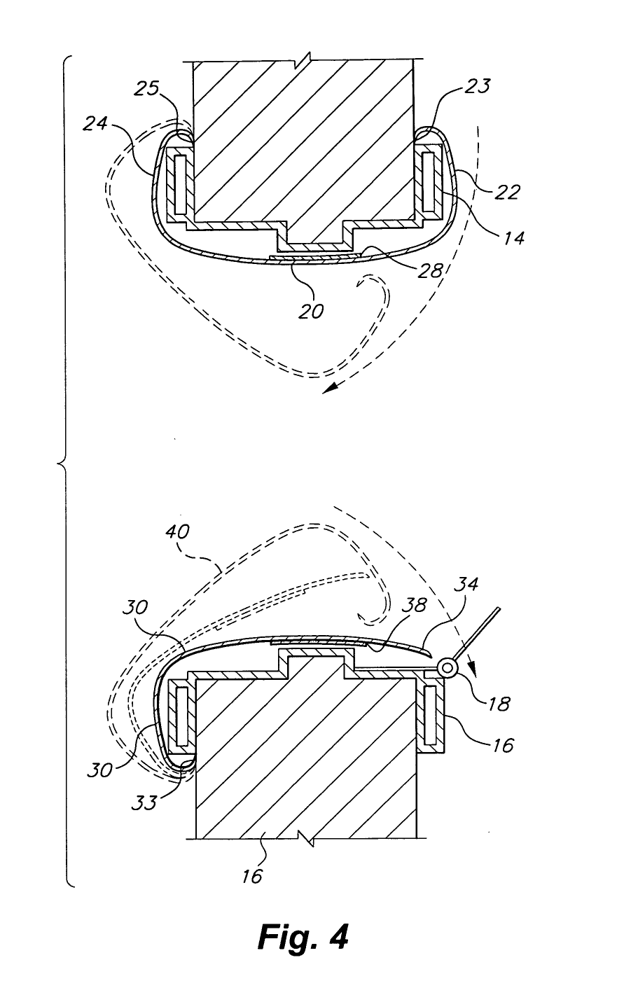

Turning to FIGS. 2-4, the latch side protector 20 is an elongated shell having a C-shaped cross section defined by a symmetrical arcuate shape with opposing, longitudinal, inwardly curved side walls 22, 24 each having inwardly curled edges 23, 25. The C-shaped cross section allows the latch side protector 20 to snap into place over a door frame, held in place by the inwardly curled edges 23, 25 of the side walls 22, 24. Padding strips 28 are disposed longitudinally along an inside surface 26 of the latch side protector 20, to further protect the door frame when the latch side protector 20 is in place. A single padding strip 28 may run the length of the latch side protector 20, or a plurality of shorter padding strips 28 may be spaced along the length of the latch side protector 20. The latch side protector 20 is installed by engaging the inwardly curled edge 23 of a first side wall 22 of the latch side protector 20 on the door frame, and flexing the latch side protector 20 to snap the second side wall 22 in place on the door frame. A plurality of finger holes 29 may be formed along one or both of the side walls 22, 24 to facilitate installation and removal of the latch side protector 20.

The hinge side protector 30 is similar to the latch side protector 20, but has a single longitudinal, inwardly curved side wall 32 having an inwardly curled edge 33, and a side-less edge 34 opposite the side wall 32, giving the hinge side protector 30 a J-shaped cross section. Padding strips 38 are disposed longitudinally along an inside surface 36 of the hinge side protector 30, to further protect the door frame when the hinge side protector 30 is in place. A single padding strip 38 may run the length of the hinge side protector 30, or a plurality of shorter strips may be spaced along the length of the hinge side protector 30.

Securing pieces 40 have a shape similar to the latch side protector 20, but are shorter in length. Securing pieces 40 are used to secure the hinge side protector 30 in place, and to provide additional protection to the door frame between hinges 18. The hinge side protector 30 is installed by engaging the inwardly curled edge 33 of the side wall 32 of the latch side protector 30 on the hinge side 16 of the door frame 12 opposite the hinges 18, with the side-less edge 34 alongside the hinges 18. Securing pieces 40 are placed over the hinge side protector 30, snapped in place similarly to the latch side protector 20.

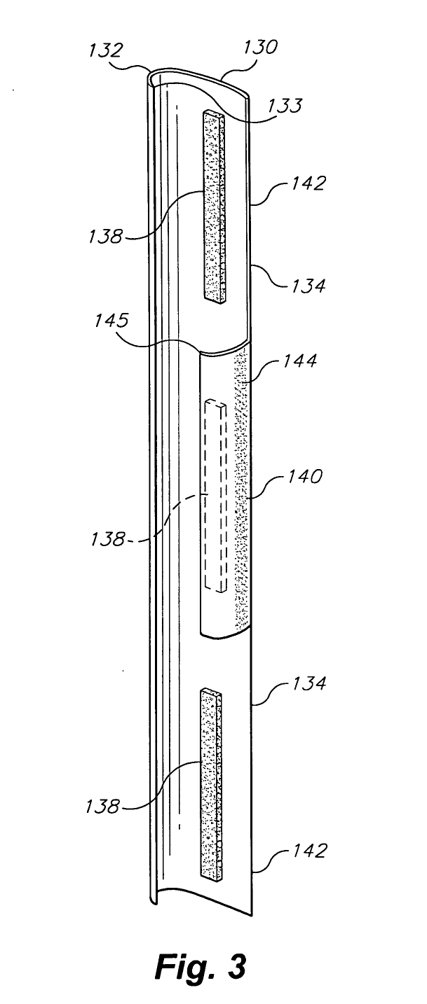

An alternate embodiment of a hinge side protector 130 is shown in FIG. 3. The hinge side protector 130 is similar to the hinge side protector 30, with a first longitudinal, inwardly curved side wall 132 having an inwardly curled edge 133 running the length of the hinge side protector 130. The side of the hinge side protector opposite the side wall 132 includes a lengthwise central portion 140 having a second longitudinal, inwardly curved side wall 144 having an inwardly curled edge 145, giving the central portion 140 a C-shaped cross section. The length of the second side wall 133 is substantially less than the overall length of the hinge side protector 130. End portions 142 of the side of the hinge side protector opposite the first side wall 132 have a side-less edge 134, giving the end portions 142 a J-shaped cross section. The hinge side protector 130 may be snapped into place in the same manner as the latch side protector 20. Securing pieces 40 are used along with the hinge side protector 130 for added protection adjacent to hinges.

The door frame protector 10 can be made from polystyrene, vinyl, polypropylene, and like materials. Because the door frame protector 10 is quickly installable and removable, the door frame protector 10 is reusable at multiple jobsites. The flexible design of the door frame protector 10 facilitates use on all types of doorframes, and all door types and hinge patterns. It can be appreciated that, because door frames vary in dimensions and hinge placement and configuration, the door frame protectors 10 can be produced in various sizes and configurations. The devices can also be produced in various colors to be more noticeable by workmen.

It is to be understood that the present invention is not limited to the sole embodiment described above, but encompasses any and all embodiments within the scope of the following claims.

I claim:

1. A door frame protector, comprising:
an elongated, flexible latch-side protector having an inside surface, the latch-side protector having a pair of opposing longitudinal side walls, each of the side walls having an edge curled inward toward the inside surface.

2. The door frame protector according to claim 1, further comprising at least one strip of a padding material disposed longitudinally along said inside surface.

3. The door frame protector according to claim 1, further comprising a plurality of apertures defined in, and longitudinally spaced along, at least one of said side walls.

4. A door frame protector, comprising:
an elongated, flexible hinge-side protector having an inside surface, the hinge-side protector having a first longitudinal side wall, the longitudinal side having an edge curled inward toward the inside surface, the hinge-side protector having a side-less edge opposite said side wall.

5. The door frame protector according to claim 4, further comprising at least one strip of a padding material disposed longitudinally along said inside surface.

6. The door frame protector according to claim 4, further comprising at least one securing piece, the securing piece being an elongated, flexible member having an inside surface and a pair of opposing longitudinal side walls, each of the side walls having an edge curled inward toward the inside surface.

7. The door frame protector according to claim 4, further comprising a second longitudinal side wall disposed along said side-less edge, the second side wall having an edge curled inward toward the inside surface, the second side wall having a length substantially shorter than the length of said side-less edge.

8. The door frame protector according to claim 7, wherein said second side wall is centered along said side-less edge.

9. A door frame protector, comprising:
an elongated, flexible latch-side protector having an inside surface, the latch-side protector having a pair of opposing longitudinal side walls, each of the side walls having an edge curled inward toward the inside surface; and
an elongated, flexible hinge-side protector having an inside surface, the hinge-side protector having a first longitudinal side wall, the first side wall having an edge curled inward toward the inside surface, the hinge-side protector having a side-less edge opposite said first side wall.

10. The door frame protector according to claim 9, further comprising at least one strip of a padding material disposed longitudinally along the inside surface of said latch-side protector.

11. The door frame protector according to claim 9, further comprising at least one strip of a padding material disposed longitudinally along the inside surface of said hinge-side protector.

12. The door frame protector according to claim 9, further comprising a plurality of apertures defined in, and longitudinally spaced along, at least one of the side walls of said latch-side protector.

13. The door frame protector according to claim 9, further comprising at least one securing piece, the securing piece being an elongated, flexible member having an inside surface and a pair of opposing longitudinal side walls, each of the side walls having an edge curled inward toward the inside surface.

14. The door frame protector according to claim 9, wherein said hinge-side protector further comprises a second longitudinal side wall disposed along said side-less edge, the second side wall having an edge curled inward toward the inside surface, the second side wall having a length substantially shorter than the length of said side-less edge.

15. The door frame protector according to claim 14, wherein said second side wall is centered along said side-less edge.
